(19) United States
(12) Patent Application Publication
(10) Pub. No.: US 2025/0300322 A1
(43) Pub. Date: Sep. 25, 2025

(54) Easily Wettable Separator for Energy Storage Devices

(71) Applicant: Celanese International Corporation, Irving, TX (US)

(72) Inventors: David Ditter, Russelsheim (DE); Christian Ohm, Sulzbach (DE); Cheng Wan, Shanghai (CN)

(21) Appl. No.: 19/085,024

(22) Filed: Mar. 20, 2025

Related U.S. Application Data
(60) Provisional application No. 63/661,975, filed on Jun. 20, 2024.

(30) Foreign Application Priority Data
Mar. 22, 2024 (WO) PCT/CN2024/083239

(51) Int. Cl. H01M 50/491; H01M 10/42; H01M 50/417

(52) U.S. Cl. CPC H01M 50/491; H01M 10/4235; H01M 50/417

(57) ABSTRACT

Porous polymer films including membranes are disclosed that have an improved blend of properties. Porous polymer films made according to the present disclosure can show dramatically improved wicking properties when tested against electrolyte solutions, indicating a significant increase in ion conductivity. The films can also be formed with porosity properties, permeability properties, strength properties, and at thicknesses that further enhance performance.

### RELATED APPLICATIONS

The present application is based upon and claims priority to International Patent Application No. PCT/CN2024/083239, having a filing date of Mar. 22, 2024, and U.S. Provisional Patent Application Ser. No. 63/661,975, having a filing date of Jun. 20, 2024, both of which are incorporated herein by reference in their entirety.

### BACKGROUND

Polyethylene polymers have numerous and diverse uses and applications. For example, high density polyethylenes are valuable engineering plastics, with a unique combination of abrasion resistance, surface lubricity, chemical resistance and impact strength. They find application in the production of high strength fibers for use in ropes and anti-ballistic shaped articles and in the production of other elongated articles, such as membranes for electronic devices. However, since the flowability of these materials in the molten state decreases as the molecular weight increases, processing by conventional techniques, such as melt extrusion, is not always possible.

One alternative method for producing fibers and other elongated components from polyethylene polymers is by gel-processing in which the polymer is combined with a solvent. The resultant gel is extruded into a fiber or membrane and may be stretched in one or two directions. After the article is formed, all of the solvent may be removed from the product.

Films made from polyethylene polymers through gel-processing can be formed to have many beneficial properties. For instance, the films can be formed with micro-pores. Microporous polyethylene films formed through gel-processing, for instance, are particularly well suited for use as a separator in a battery, such as a lithium ion battery. The microporous film, for instance, can separate an anode from a cathode and prevent a short circuit between the active battery components. At the same time, the microporous film permits ions to pass through due to the porous nature of the material. The ion permeability characteristics of the microporous polyethylene film makes the material particularly well suited for regulating electrochemical reactions within the battery.

In view of the above, one of the important characteristics of ion battery films is the compatibility between the membrane and the electrolyte solution. In this regard, the present disclosure is directed to improved porous membranes or films with increased wicking or soaking compatibility characteristics when contacted with electrolytes. The present disclosure is also directed to porous polymer films that display improved ion conductivity when positioned between an anode and a cathode of an electronic device, such as an ion battery. The present disclosure is also directed to porous polymer films that have improved ion conductivity and/or wicking characteristics in combination with a blend of optimum physical properties. The present disclosure is also directed to porous polymer films that improve battery lifetime and battery manufacturing productivity.

### SUMMARY

In general, the present disclosure is directed to porous polymer films that are well suited for use in electronic devices. The porous polymer films can be used as ion permeable membranes positioned between an anode and a cathode. The porous polymer films are generally formed from one or more high density polyethylene polymers that also have a high molecular weight. In accordance with the present disclosure, the porous polymer films or membranes are produced with a blend of properties that make the films well suited for use as a separator between an anode and a cathode in an energy storage device. In one aspect, the porous polymer films or membranes include an electrolyte compatibility treatment (additive and/or surface treatment) for dramatically improving the ability of the porous polymer film or membrane to wick electrolyte materials.

In one aspect, the present disclosure is directed to a separator for separating an anode from a cathode in an energy storage device. The separator comprises a porous membrane comprising at least one high density polyethylene polymer. The at least one high density polyethylene polymer having an average molecular weight of from about 400,000 g/mol to about 13,000,000 g/mol, the at least one high density polyethylene polymer being present in the porous membrane in an amount of at least about 30% by weight, the porous membrane having a thickness of from about 3 microns to about 25 microns, the porous membrane having a Gurley permeability of from about 50 sec/100 mL to about 1,000 sec/100 mL, the porous membrane having a porosity of from about 20% to about 60%, and wherein, in one aspect, the porous membrane displays an electrolyte wetting property such that the porous membrane displays a soaking distance according to the following relationship when tested in propylene carbonate:

soaking distance (mm)≥−0.1473x+13.935

wherein x is Gurley permeability (sec/100 mL) per thickness of the porous membrane (microns).

In other embodiments, the porous membrane can optionally display a soaking distance according to one of the following relationships:

soaking distance (mm)≥−0.1473x+14.5

wherein x is Gurley permeability (sec/100 mL) per thickness of the porous membrane (microns);

soaking distance (mm)≥−0.1473x+15.5

wherein x is Gurley permeability (sec/100 mL) per thickness of the porous membrane (microns).

In addition to displaying improved soaking distances, the porous membranes of the present disclosure can also display very quick soaking speeds. For instance, when tested against propylene carbonate, the membrane can display a soaking speed of greater than about 0.52 mm/hr, such as greater than about 0.55 mm/hr, such as greater than about 0.58 mm/hr, such as greater than about 0.6 mm/hr, such as greater than about 0.62 mm/hr, such as greater than about 0.65 mm/hr, such as greater than about 0.68 mm/hr, such as greater than about 0.7 mm/hr, such as greater than about 0.72 mm/hr, such as greater than about 0.75 mm/hr, such as greater than about 0.78 mm/hr, such as greater than about 0.8 mm/hr, such as greater than about 0.82 mm/hr after 20 hours. The above soaking speeds can be attained for membranes having a Gurley permeability/thickness value of from about 10 s/100 cc/μm to about 40 s/100 cc/μm, such as from about 15 s/100 cc/μm to about 35 s/100 cc/μm, such as from about 20 s/100 cc/μm to about 32 s/100 cc/μm.

Of particular advantage, porous membranes made according to the present disclosure not only have excellent wicking characteristics when tested against electrolytes, but also display excellent strength properties in combination with optimum porosity and permeability properties. In one aspect, the porous membrane can have a porosity of from about 25% to about 60%, such as from about 35% to about 55%. The porous membrane can display a Gurley permeability of greater than about 50 sec/100 mL, such as greater than about 100 sec/100 mL, such as greater than about 120 sec/100 mL, such as greater than about 200 sec/100 mL, such as greater than about 300 sec/100 mL, such as greater than about 400 sec/100 mL. In addition, the porous membrane can display a thickness normalized puncture strength of greater than about 500 mN/micron, such as greater than about 800 mN/micron, such as greater than about 1,300 mN/micron.

The porous membrane can contain a single high density polyethylene polymer or a blend of high density polyethylene polymers. In one aspect, at least one of the high density polyethylene polymers contained in the porous membrane has a molecular weight of from about 600,000 g/mol to about 4,000,000 g/mol. In one aspect, the porous membrane is a single layer membrane that does not contain any polypropylene polymers.

In one aspect, in order for the porous membrane to display excellent wicking properties as described above with respect to electrolytes, the porous membrane can be subjected to at least one wicking enhancing treatment and/or may contain at least one wicking enhancing agent. The wicking enhancing treatment, for instance, may comprise subjecting one or both surfaces of the porous membrane to plasma. For instance, one or both surfaces of the porous membrane can be plasma oxidized to form polar groups attached to the high density polyethylene polymer.

In addition to a surface treatment or instead of a surface treatment, the porous membrane can contain one or more wicking enhancing agents. Examples of wicking enhancing agents include an ethylene vinyl acetate, a polyethylene polymer grafted to hydrophilic groups or combinations thereof.

The at least one wicking enhancing treatment and/or at least one wicking enhancing agent can dramatically increase soaking distances and soaking speeds. For example, membranes subjected at least one wicking enhancing treatment and/or containing at least one wicking enhancing agent can display a soaking distance and/or soaking speed that is at least 5% greater, such as at least 10% greater in comparison to a reference identical membrane not subjected at least one wicking enhancing treatment and/or containing at least one wicking enhancing agent.

One or more high density polyethylene polymers may be contained in the porous membrane in an amount from about 60% by weight to about 99.5% by weight, such as from about 80% by weight to about 98% by weight. In one embodiment, the porous polymer film is made from a single high density polyethylene polymer. In another aspect, the porous polymer film can be made from a blend of high density polyethylene polymers, such as a blend of three high density polyethylene polymers. The polyethylene polymers can be a Ziegler-Natta catalyzed high molecular weight polyethylene polymers. The porous polymer film can also be a single layer porous polymer film that may optionally include a coating. Coatings that may be applied to the film include inorganic coatings and/or polymer coatings. The porous polymer film can be biaxially stretched.

### BRIEF DESCRIPTION OF THE DRAWINGS

A full and enabling disclosure of the present disclosure is set forth more particularly in the remainder of the specification, including reference to the accompanying figures, in which:

FIG. 1 is a cross-sectional view of an electronic device, such as a battery, incorporating a porous membrane or film made in accordance with the present disclosure;

FIG. 2 is one embodiment of an oxygen plasma process that may be used to treat porous polymer films in accordance with the present disclosure; and

FIG. 3 is a graphical representation of some of the results obtained in the example below.

Repeat use of reference characters in the present specification and drawings is intended to represent the same or analogous features or elements of the present invention.

### Definitions

The melt flow rate of a polymer or polymer composition is measured according to ISO Test 1133 at 190° C. and at a load of 21.6 kg.

The density of a polymer is measured according to ISO Test 1183 in units of g/cm³.

Average particle size (d50) is measured using laser diffraction/light scattering, such as a suitable Horiba light scattering device.

The average molecular weight of a polymer is determined using the Margolies' equation.

Tensile modulus, tensile stress at yield, tensile strain at yield, tensile stress at 50% break, tensile stress at break, and tensile nominal strain at break are all measured according to ISO Test 527-2/1B.

The full width at half maximum of a melting endothermic peak of a sample is measured with a differential scanning calorimeter (DSC). An electronic balance is used to measure 8.4 g of a sample. The sample is placed in an aluminum sample pan. An aluminum cover is attached to the pan, which is set in the differential scanning calorimeter. The sample and a reference sample are retained at 40° C. for one minute while nitrogen purge is performed at a flow rate of 20 mL/min then heated from 40° C. to 180° C. at a heating rate of 10° C./min, retained at 180° C. for 5 minutes, and then cooled to 40° C. at a cooling rate of 10° C./min. A baseline is drawn from 60° C. to 150° C. in the melting curve acquired during the process and the full width at half maximum of a melting endothermic peak is derived using analysis software, such as “Pyris Software (Version 7).” The test can be conducted using a DSC Q2000 calorimeter available from TA Instruments.

The half-crystallization period of time during an isothermal crystallization at 123° C. can be determined from the time that requires a quantity of heat measured during an isothermal crystallization measurement at 123° C. to correspond to the half of the peak area in differential scanning calorimetry (DSC) measurement. The test can be conducted using a DSC Q2000 calorimeter available from TA Instruments.

A soaking test may be used to determine the wicking characteristics of membranes made in accordance with the present disclosure according to the following procedure.

For the soaking test a glass vessel is used with following dimensions: 20×10 cm upper area (covered with a metal plate)/19×8 cm lower area (base)/height: 10 cm). Two filter papers are sticked at the inside of the glass vessel with a tape. 300 ml propylene carbonate is filled into the vessel afterwards (fluid level: 2 cm). The vessel is covered with a metal plate and propylene carbonate is allowed to fill the gas space for 20 minutes.

Membranes are cut with scissors into pieces (length: 70 mm, width: 7 mm). This is done with nitrile gloves to prevent touching the membranes with the bare hand. The pieces are mounted on an anodized metal plate (140 mm×70 mm, frame width: 10 mm, slope: 80°) with the help of magnets. The MD direction of membranes shows upwards (=soaking direction).

The metal frame with the fixed membranes are then moved 40 times through a deionizer to remove electrostatic charges. After that the frame is placed into the vessel filled with propylene carbonate at room temperature and soaking of the membranes with propylene carbonates takes place for a desired time. During soaking takes place the vessel is closed with a metal plate. The different soaking distances of the membranes are measured every 30 minutes by taking a photo and measuring the distance with a suitable computer program.

Soaking distances of tested membranes is compared to draw conclusion on their battery electrolyte affinity.

Gurley permeability can be measured according to the Gurley Test, using a Gurley permeability tester, such as Gurley Densometer, Model KRK 2060c commercially available from Kumagai Riki Kogyo Co., LTD. The test is conducted according to ISO Test 5636. The Gurley Test measures air permeability as a function of the time required for a specified amount of air to pass through a specified area under a specified pressure. The units are reported in sec/100 ml.

The soaking test as described above is to be conducted on membranes made according to the process as described below.

In order to produce membranes for conducting the soaking test, an oil/polymer resin slurry is first prepared containing 70% by weight oil and 30% by weight polymer resin. The slurry is prepared manually and batch-wise. The paraffin oil used is FINAVESTAN A 360 B oil from TOTAL Deutschland GmbH. The oil and polymer mixture is stirred for 20-30 minutes at 70 rpm with a mechanical stirrer until a homogeneous slurry is obtained. The slurry is fed to an extruder from a stirred vessel using a pump. The pump ensures a steady flow (feed/dosage rate) of the slurry into the extruder via a dosage system from Colortronic Systems (serial number: 10A41AE-1001).

The feed/dosage rates of the slurry depend on the average molecular weight of the polyethylene polymer. If multiple polyethylene polymers are used, the molecular weights of the polymers are weight averaged. The feed/dosage rates are as follows:
200,000 g/mole to 800,000 g/mole: 2.5±0.2 kg/h
Above 800,000 g/mole to 1,400,000 g/mole: 2±0.2 kg/h
Above 1,400,000 g/mole: 1.5±0.2 kg/h

The extruder used is model/serial number ZSE18HPe-550 sold/manufactured by Leistritz. The extruder is paired with a melt pump having model/serial number EXTREX Typ 21 SP sold/manufactured by Maag Pump Systems AG. The die used is a T-die model/serial number 0240-02-10 sold/manufactured by Collin. The rollers used during the process were obtained from Fisher Scientific.

The extrusion is done at an extrusion temperature of 210° C. and a screw RPM of 200 RPM.

The extruder has co-rotating non-intermeshing twin screws with a length of 979 mm. The screw diameter is 17.8 mm (L/D=55). The extruder is equipped with 12 electrical heating elements (10.5 KW overall). The maximum rotational speed is 1200 rpm at a maximum torque of 2×35.5 Nm. At the end of the extruder there is a temperature controlled melt pump. The melt pump is followed by a T-die with a slid width of 150 mm and a slid thickness selectable between 0.2 and 2.0 mm. The T-die is equipped with three additional heating elements.

The gel sheet is cast into free space behind the die opening. The film is taken up by a set of chromium plated rollers that are set to 40° C. (chill roll temperature). The distance between the die opening and chill roll is ˜ 10 cm. After the chill roll, the cast film is rolled up. The roller system including chill rolls and rolls used to roll up the cast film is from LabTech Engineering Co, model: LCR-175, machine number: LCR 1808-494.

The final gel sheet has a thickness of 0.85 mm (+−0.1 mm) and a width of 8-12 cm.

The gel sheet is cut into square shapes and stretched with a ratio of 7 by 7 at 120° C. with a stretching device from Brückner (Brückner KARO IV model, Structure 851). The plasticized membrane pieces have a size of ˜49×49 cm. From these 30±2 cm membrane pieces are cut and extracted in an acetone bath to remove the oil. Annealing is performed in an oven for 10 min. at 110° C. (Binder Oven, model: FD260).

Afterwards the Gurley of the membrane is measured. Each Gurley measurement involves the measurement of a circular membrane area having a diameter of ˜2.8 cm. Two of these measurements are done next to each other. From two measurements done next to each, average values of Gurley and thickness are calculated to estimate Gurley/thickness values. Gurley measurements are done with Gurley Densometers, model presica-4110N+4320EN. Membrane thickness measurements are done with a L&W micrometer, made by Lorentzen and Wettre, model: SE251.

In a next step, membrane strips are cut from the areas Gurley and thickness were measured. Length of samples is 7 cm. Width of samples is 1 cm. Length of samples are cut into machine direction and the width of samples in the cross direction. The 7×1 cm samples are used to perform the soaking test.

Porosity (%) is measured according to the following procedure. During the procedure, the following ASTM Standards are used as a reference: D622 Standard Test Method for Apparent Density of Rigid Cellular Plastics1; and D729 Standard Test Methods for Density and Specific Gravity (Relative Density) of Plastics by Displacement1. The following instruments are used: Calibrated Analytical Balance (0.0001 grams); Lorentzen & Wettre Micrometer,code 251 (0.1 um); and Deli 2056 art knife.

### Procedure:

### 1.1. Samples and Sample Preparation

Using the specimen art knife, cut each sample material into a minimum of three 60 mm±0.5 by 60 mm±0.5 specimens

### 1.2. Instrument and Measurement

3.2.1 Using the L&W micrometer, take five readings of the thickness at each 60 mm by 60 mm specimen (average of 5 readings). Record this value as the thickness of this specimen.

3.2.2 Weigh the specimen directly on the balance. Record this value as the weight of this specimen.

3.2.3 The three specimens of the same sample are placed together and steps 3.2.1 and 3.2.2 are repeated to obtain the [bulk] thickness and the [bulk] weight.

Calculate the density to three significant figures as follows
a.

$$Dfilm = Density ( film ) = \frac{Wt . of Specimen}{{THK}^{*} Square}$$

Dfilm=density of specimen, (mg/mm3)
Wt=weight of specimen, (mg)
THK=thickness of specimen, (mm)
Square=area of specimen, (mm2)
b.

$$Dpolymer = Density ( polymer ) 0.95 ( g / cm 3 )$$

Dpolymer: Density of raw materials, without the pores.
c.

$$Porosity = ( 1 - Dfilm / Dpolymer ) * 100 \%$$

As used herein, puncture strength is measured according to ASTM Test D3763 and measures the ability of a membrane to withstand a foreign particle from causing a hole or defect. The test is conducted on a testing device, such as an Instron CEAST 9340 device. The drop height is 0.03 to 1.10 m. The impact velocity is 0.77 to 4.65 m/s. The maximum dropping mass is 37.5 kg and the maximum potential energy is 405 J. Puncture strength is measured in slow speed puncture mode at 1.67 mm/s. Puncture strength can be normalized by dividing by the thickness of the membrane resulting in units of mN/micron.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to porous polymer films made from at least one high density polyethylene polymer. In accordance with the present disclosure, the porous polymer films or membranes are constructed to have a blend of properties that make them well suited for use as a separator in an energy storage device. The membranes or films, for instance, have a desired porosity range and have a desired permeability range in conjunction with a desired thickness. The films and membranes are also relatively strong and have excellent puncture strength characteristics. In addition, the porous membranes or films have excellent wicking properties when contacted with an electrolyte.

The porous polymer film is particularly well suited for use as an ion separator in an electronic device, such as a lithium ion battery or a sodium ion battery. These battery cells are filled with an electrolyte solution. The electrolyte solution typically contains an alkylene carbonate, such as propylene carbonate, in combination with an ion producing compound such as a lithium compound or sodium compound. The ion producing compound can, in one aspect, be lithium hexafluorophosphate. The ion producing compound can be dissolved in the electrolyte solution.

As worldwide demand for ion batteries continues to increase, there is a great need and desire in the industry to improve battery manufacturing productivity in order to save costs, time, and resources. At the same time, making batteries with increased performance and lifetime is an ongoing goal in order to meet rising expectations of the market.

One way to increase battery manufacturing productivity is to decrease the time needed for single manufacturing steps. Electrolyte filling, charging and discharging (i.e. formation), as well as aging are some of the more time-consuming steps during the manufacture of batteries. The present inventors discovered that the wicking characteristics of the battery separator and the affinity of the electrolyte for the separator dramatically impact one or more of the above steps during the manufacture of the battery.

Although porous polymer films made from high density polyethylene polymers have excellent mechanical and porous properties, the films do not have a high affinity for the polar electrolyte. This incompatibility leads to a time consuming battery production process where the porous polymer film made from the polyethylene polymer needs to be soaked with the polar electrolyte. Incomplete electrolyte filling and poor compatibility between the porous polymer film and the electrolyte can lead to reduced performance of the battery, reduced lifetime, high internal resistance, and reduced energy density. In this regard, the porous polymer film of the present disclosure is subjected to at least one wicking enhancing treatment and/or contains at least one wicking enhancing agent that greatly increases the affinity of at least the surface of the film to a polar electrolyte.

In accordance with the present disclosure, the wicking properties and electrolyte compatibility of the membranes are dramatically improved without interfering with other properties of the membranes such as porosity, permeability, thickness, and strength. Porous membranes made in accordance with the present disclosure can facilitate certain steps in producing batteries when used as separators. For example, during battery formation aging/formation can be faster and electrolyte filling can be faster, while producing batteries with better overall properties and lifetime.

The wicking properties or ion conductivity characteristics of the porous membranes can be exemplified by testing the affinity of the membranes to an electrolyte during a soaking test, which determines the ability of the membrane to wick electrolyte fluids, such as propylene carbonate. The wicking or soaking distance can be dependent upon the permeability of the membrane and the thickness of the membrane. By incorporating one or more wicking enhancing agents and/or subjecting one or both surfaces of the membrane to a wicking enhancing treatment, porous membranes according to the present disclosure can display a dramatically improved soaking distance.

For example, the wicking enhancing treatment and/or wicking enhancing agent can be present in the porous membrane sufficient to increase a wicking distance of the membrane when measured according to a soaking test using propylene carbonate. The wicking distance can be increased in an amount of greater than about 5%, such as greater than about 10%, such as in an amount greater than about 20%, such as in an amount greater than about 30%, such as in an amount greater than about 35% in comparison to an identical porous membrane not containing the wicking enhancing agent and/or not being subjected to a wicking enhancing treatment.

Optionally, in one embodiment, the soaking distance can be according to the following formula:

$$Soaking distance ( mm ) \geq - 0.1473 ( x ) + 13.935$$

wherein x is the Gurley permeability (sec/100 mL)/thickness (microns).

In other embodiments, the soaking distance can be according to the following relationships:

$$\begin{matrix}Soaking distance ( mm ) \geq - 0.1473 ( x ) + 15. \\ Soaking distance ( mm ) \geq - 0.1473 ( x ) + 15.5 \\ Soaking distance ( mm ) \geq - 0.1473 ( x ) + 16. \\ Soaking distance ( mm ) \geq - 0.1473 ( x ) + 16.5 \\ Soaking distance ( mm ) \geq - 0.1473 ( x ) + 17.\end{matrix}$$

wherein x is the Gurley permeability (sec/100 mL)/thickness (microns).

In addition to dramatically improved soaking distances, porous membranes made according to the present disclosure also display dramatically improved soaking speeds. For example, the wicking enhancing treatment and/or wicking enhancing agent can be present in the porous membrane sufficient to increase a soaking speed of the membrane when measured using propylene carbonate after 20 hours. The soaking speed can be increased in an amount of greater than about 5%, such as greater than about 10%, such as in an amount greater than about 20%, such as in an amount greater than about 30%, such as in an amount greater than about 35% in comparison to an identical porous membrane not containing the wicking enhancing agent and/or not being subjected to a wicking enhancing treatment.

For instance, when contacted with propylene carbonate for 20 hours, the porous membranes of the present disclosure can display a soaking speed of greater than about 0.55 mm/h, such as greater than about 0.6 mm/h, such as greater than about 0.65 mm/h, such as greater than about 0.7 mm/h, such as greater than about 0.75 mm/h, such as greater than about 0.77 mm/h, such as greater than about 0.8 mm/h, such as greater than about 0.82 mm/h. The soaking speed is generally less than about 5 mm/h over 20 hours. The above soaking speeds can be attained for membranes having a Gurley permeability/thickness value of from about 10 s/100 cc/μm to about 40 s/100 cc/μm, such as from about 15 s/100 cc/μm to about 35 s/100 cc/μm, such as from about 20 s/100 cc/μm to about 32 s/100 cc/μm.

Porous membranes or films made according to the present disclosure can generally have a thickness of greater than about 3 microns, such as greater than about 4 microns, such as greater than about 5 microns, such as greater than about 6 microns, such as greater than about 7 microns, such as greater than about 8 microns, such as greater than about 9 microns. The thickness of the membranes or films is generally less than about 25 microns, such as less than about 16 microns, such as less than about 14 microns, such as less than about 12 microns, such as less than about 10 microns, such as less than about 8 microns.

Membranes or films made according to the present disclosure can have excellent physical properties. For example, membranes or films having a porosity of from about 25% to about 60%, such as from about 35% to about 55%, can have a thickness normalized puncture strength of greater than about 500 mN/micron, such as greater than about 800 mN/micron, such as greater than about 1,200 mN/micron, such as greater than about 1,400 mN/micron, such as greater than about 1,475 mN/micron, such as greater than about 1,500 mN/micron, such as greater than about 1,525 mN/micron, such as greater than about 1,550 mN/micron, such as greater than about 1,575 mN/micron, such as greater than about 1,600 mN/micron, such as greater than about 1,625 mN/micron, such as greater than about 1,650 mN/micron, and generally less than about 3,000 mN/micron. The unit weight normalized pin puncture strength can be greater than about 120 gf/g/cm2, such as greater than about 200 gf/g/cm2, such as greater than about 250 gf/g/cm2, such as greater than about 252 gf/g/cm², such as greater than about 254 gf/g/cm², such as greater than about 256 gf/g/cm², such as greater than about 258 gf/g/cm², such as greater than about 260 gf/g/cm², such as greater than about 262 gf/g/cm², and generally less than about 300 gf/g/cm².

At a membrane or film porosity of from about 39% to about 50%, the membrane or film can have a thickness normalized puncture strength of greater than about 300 mN/micron, such as greater than about 340 mN/micron, such as greater than about 350 mN/micron, such as greater than about 360 mN/micron, such as greater than about 370 mN/micron, such as greater than about 380 mN/micron, such as greater than about 390 mN/micron, such as greater than about 400 mN/micron, and generally less than about 2000 mN/micron and can have a unit weight normalized pin strength of greater than about 60 gf/g/cm², such as greater than about 65 gf/g/cm², such as greater than about 72 gf/g/cm², such as greater than about 74 gf/g/cm², such as greater than about 76 gf/g/cm², such as greater than about 78 gf/g/cm², such as greater than about 80 gf/g/cm², such as greater than about 82 gf/g/cm², and generally less than about 300 gf/g/cm².

Membranes or films made according to the present disclosure can also have excellent tensile strength properties in either the machine direction or the cross-machine direction. For instance, in either direction, the membrane or film can have a tensile strength of greater than about 50 MPa, such as greater than about 100 MPa, such as greater than about 125 MPa, such as greater than about 140 MPa, such as greater than about 150 MPa, such as greater than about 160 MPa, such as greater than about 162 MPa, such as greater than about 164 MPa, such as greater than about 166 MPa, such as greater than about 168 MPa, such as greater than about 170 MPa, and generally less than about 300 MPa.

Polymer membranes or films made according to the present disclosure can have a Gurley permeability of greater than about 50 sec/100 mL, such as greater than about 70 sec/100 mL, such as greater than about 105 sec/100 mL, such as greater than about 120 sec/100 mL, such as greater than about 150 sec/100 mL, such as greater than about 200 sec/100 mL, such as greater than about 225 sec/100 mL, such as greater than about 250 sec/100 mL, such as greater than about 275 sec/100 mL, such as greater than about 300 sec/100 mL, such as greater than about 325 sec/100 mL, such as greater than about 350 sec/100 mL, such as greater than about 375 sec/100 mL, such as greater than about 400 sec/100 mL, such as greater than about 425 sec/100 mL, such as greater than about 450 sec/100 mL, such as greater than about 475 sec/100 mL, such as greater than about 500 sec/100 mL, such as greater than about 525 sec/100 mL, such as greater than about 550 sec/100 mL, such as greater than about 575 sec/100 mL, such as greater than about 600 sec/100 mL, and generally less than about 1,000 sec/100 mL.

In order to improve the compatibility of the porous membrane with an electrolyte, in accordance with the present disclosure, the porous membrane contains one or more wicking enhancement agents and/or is subjected to one or more wicking enhancement treatments, such as a plasma treatment.

In one aspect, for instance, one or more wicking enhancing agents can be combined with the polyethylene polymer in order to improve the wicking characteristics of articles made from the composition. Wicking enhancing agents that may be used in accordance with the present disclosure generally comprise any suitable additive that can be melt processed with the high density polyethylene particles and lower the surface tension of articles made from the polymer composition. The wicking enhancing agent, for instance, can be a hydrophilic inorganic filler, hydrophilic organic polymeric particles, a hydrophilic chemical agent that forms functional hydrophilic chemical groups on the polymer, or combinations thereof.

In one aspect, the wicking enhancing agent can comprise a polyolefin polymer particularly a polyethylene polymer functionalized with an organic acid, such as an organic acid anhydride. For example, the polyolefin polymer, such as a polyethylene polymer, can be modified to include hydrophilic carboxyl groups. The carboxyl groups can be added to the polymer by oxidation, by polymerization, or by grafting. For example, in one aspect, carboxyl-containing unsaturated monomers can be grafted to a polyolefin polymer, such as a polyethylene polymer. The carboxyl-containing unsaturated monomer, for instance, can be maleic acid anhydride.

For example, in one aspect, the wicking enhancing agent can be a polyethylene polymer functionalized with maleic acid anhydride. The polyethylene polymer can be the same as the high density polyethylene polymer that is combined with the wicking enhancing agent or can be a different polyethylene polymer. For example, the polyethylene polymer functionalized with the maleic acid anhydride can be a low density polyethylene polymer, such as a linear low density polyethylene polymer. Alternatively, the polyethylene polymer functionalized with the maleic acid anhydride can be a high density polyethylene polymer. The high density polyethylene polymer can have a molecular weight of greater than about 300,000 g/mol, such as greater than about 500,000 g/mol, such as greater than about 600,000 g/mol, such as greater than about 700,000 g/mol, and generally less than about 8,000,000 g/mol.

The polyethylene polymer functionalized with the maleic acid anhydride can contain maleic acid anhydride in an amount generally greater than about 1.5% by weight, such as in an amount greater than about 1.8% by weight, such as in an amount greater than about 2% by weight, such as in an amount greater than about 2.5% by weight, such as in an amount greater than about 3% by weight, such as in an amount greater than about 3.5% by weight, such as in an amount greater than about 4% by weight, such as in an amount greater than about 4.5% by weight. The polyethylene functionalized with maleic acid anhydride generally can contain the maleic acid anhydride in an amount less than about 20% by weight, such as in an amount less than about 10% by weight, such as in an amount less than about 8% by weight, such as in an amount less than about 5% by weight. The polyethylene functionalized with maleic acid anhydride can be in the form of a powder or particles that are combined or compounded with the high density polyethylene particles.

In other embodiments, the wicking enhancing agent can be a fatty alcohol glycol ether such as an ethylene-vinyl alcohol copolymer. The wicking enhancing agent can also be an ethylene acrylic acid copolymer. The ethylene acrylic acid copolymer can generally have an acrylic acid content of greater than 5% by weight, such as greater than about 8% by weight, such as greater than about 10% by weight, and generally less than about 30% by weight, such as less than about 20% by weight, such as less than about 15% by weight, such as less than about 12% by weight.

The wicking enhancing agent can be any suitable acrylate polymer and/or a graft copolymer containing an olefin. The olefin polymer, such as polyethylene, can serve as a graft base and can be grafted to at least one vinyl polymer or one ether polymer.

Examples of wicking enhancing agents as described above include ethylene-acrylic acid copolymer, ethylene-maleic anhydride copolymers, ethylene-alkyl(meth)acrylate-maleic anhydride terpolymers, ethylene-alkyl(meth)acrylate-glycidyl(meth)acrylate terpolymers, ethylene-acrylic ester-methacrylic acid terpolymer, ethylene-acrylic ester-maleic anhydride terpolymer, ethylene-methacrylic acid-methacrylic acid alkaline metal salt (ionomer) terpolymers, and the like. In one embodiment, for instance, a wicking enhancing agent can include a random terpolymer of ethylene, methylacrylate, and glycidyl methacrylate. The terpolymer can have a glycidyl methacrylate content of from about 5% to about 20%, such as from about 6% to about 10%. The terpolymer may have a methylacrylate content of from about 20% to about 30%, such as about 24%.

The wicking enhancing agent may be a linear or branched, homopolymer or copolymer (e.g., random, graft, block, etc.) containing epoxy functionalization, e.g., terminal epoxy groups, skeletal oxirane units, and/or pendent epoxy groups. For instance, the wicking enhancing agent may be a copolymer including at least one monomer component that includes epoxy functionalization. The monomer units of the wicking enhancing agent may vary. For example, the wicking enhancing agent can include epoxy-functional methacrylic monomer units. As used herein, the term (meth)acrylic generally refers to both acrylic and methacrylic monomers, as well as salts and esters thereof, e.g., acrylate and methacrylate monomers. Epoxy-functional (meth)acrylic monomers that may be incorporated in the wicking enhancing agent may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

Examples of other monomers may include, for example, ester monomers, olefin monomers, amide monomers, etc. In one embodiment, the wicking enhancing agent can include at least one linear or branched α-olefin monomer, such as those having from 2 to 20 carbon atoms, or from 2 to 8 carbon atoms. Specific examples include ethylene; propylene; 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene.

In one embodiment, the wicking enhancing agent can be a terpolymer that includes epoxy functionalization. For instance, the wicking enhancing agent can include a methacrylic component that includes epoxy functionalization, an α-olefin component, and a methacrylic component that does not include epoxy functionalization. For example, the wicking enhancing agent may be poly(ethylene-co-methylacrylate-co-glycidyl methacrylate), which has the following structure:

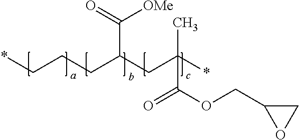

wherein, a, b, and c are 1 or greater.

In another embodiment the wicking enhancing agent can be a random copolymer of ethylene, ethyl acrylate and maleic anhydride having the following structure:

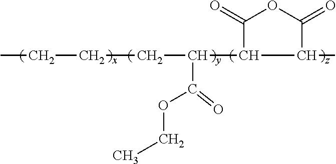

wherein x, y and z are 1 or greater.

The relative proportion of the various monomer components of a copolymeric wicking enhancing agent is not particularly limited. For instance, in one embodiment, the epoxy-functional methacrylic monomer components can form from about 1 wt. % to about 25 wt. %, or from about 2 wt. % to about 20 wt % of a copolymeric wicking enhancing agent. An α-olefin monomer can form from about 55 wt. % to about 95 wt. %, or from about 60 wt. % to about 90 wt. %, of a copolymeric wicking enhancing agent. When employed, other monomeric components (e.g., a non-epoxy functional methacrylic monomers) may constitute from about 5 wt. % to about 35 wt. %, or from about 8 wt. % to about 30 wt. %, of a copolymeric wicking enhancing agent.

The molecular weight of the above wicking enhancing agent can vary widely. For example, the wicking enhancing agent can have a number average molecular weight from about 7,500 to about 250,000 grams per mole, in some embodiments from about 15,000 to about 150,000 grams per mole, and in some embodiments, from about 20,000 to 100,000 grams per mole, with a polydispersity index typically ranging from 2.5 to 7.

In still another embodiment, the wicking enhancing agent can be a surfactant that can be melt processed with the high density polyethylene resin. For example, the surfactant can be a nonionic surfactant that is in the form of a solid at 23° C. In one aspect, for instance, the wicking enhancing agent can be an alkyl polyethylene glycol ether. The alkyl polyethylene glycol ether can be made from linear saturated C10 to C28, such as C16-C18, fatty alcohols. For example, the surfactant can be the reaction product of a fatty alcohol with ethylene oxide. The surfactant can contain a degree of ethoxylation of greater than about 8 mols, such as greater than about 10 mols, such as greater than about 20 mols, such as greater than about 30 mols, such as greater than about 40 mols, and generally less than about 100 mols, such as less than about 80 mols, such as less than about 60 mols.

In still another embodiment, the wicking enhancing agent can be a hydrophilic inorganic filler such as aluminum oxide or aluminum hydroxide. The aluminum oxide, for instance, can have a BET surface area of greater than about 85 m²/g, such as greater than about 90 m²/g, such is greater than about 100 m²/g, and generally less than about 500 m²/g, such as less than about 200 m²/g.

The hydrophilic inorganic filler can generally have a D50 particle size of less than about 30 microns, such as less than about 20 microns, such as less than about 15 microns, such as less than about 10 microns, and generally greater than about 0.1 microns, such as greater than about 0.5 microns, such as greater than about 1 micron, such as greater than about 3 microns, such as greater than about 5 microns.

In another aspect, the wicking enhancing agent can be a hydrophilic chemical agent that couples to the polyethylene polymer during melt processing or in-situ during formation of the polymer for increasing the wettability characteristics of the resulting article. The hydrophilic chemical agent, for instance, can chemically graft to the polyethylene polymer with functional chemical groups that increase the polarity of the polymer. Alternatively, the hydrophilic chemical agent can undergo a chemical reaction with other polar molecules on the polyethylene polymer for reducing surface tension.

In one aspect, for instance, the wicking enhancing agent can be an organic acid anhydride as described above that is combined with the polyethylene polymer during melt processing. For instance, the organic acid anhydride can comprise maleic acid anhydride. Alternatively, the wicking enhancing agent can be an acrylate or a methacrylate, such as glycidyl methacrylate. In still another alternative embodiment, the wicking enhancing agent can comprise an acrylic acid that contacts the polyethylene polymer in molten form and bonds with the polymer.

For example, in one embodiment, the wicking enhancing agent can comprise a polyethylene polymer that has been grafted with an acrylic acid. The amount of acrylic acid grafted to the polyethylene polymer can generally be greater than about 0.5% by weight, such as in an amount greater than about 1% by weight, such as in an amount greater than about 2% by weight, and generally in an amount less than about 25% by weight, such as in an amount less than about 15% by weight, such as in an amount less than about 10% by weight, such as in an amount less than about 8% by weight. The acrylic acid grafted polyethylene polymer can then be combined with an unmodified or ungrafted high density polyethylene polymer to form the porous polymer film. The resulting film can contain acrylic acid groups in an amount greater than about 0.01% by weight, such as greater than about 0.1% by weight, such as greater than about 0.5% by weight, such as in an amount greater than about 2% by weight, and generally in an amount less than about 15% by weight, such as in an amount less than about 10% by weight.

In one embodiment, once the acrylic acid is grafted to the polyethylene polymer, the acrylic acid can be saponified. Saponification can occur on the polymer resin or polymer particles or can occur after an article has been formed. In one aspect, the acrylic acid groups can be saponified by contacting the acrylic acid groups with a base, such as sodium hydroxide.

The grafted polyethylene polymer can be in the form of particles that are optionally blended with unmodified high density polyethylene polymer particles. The particles, for example, can have an average particle size (d50) by volume of less than about 400 microns, such as less than about 300 microns, such as less than about 200 microns, such as less than about 170 microns, such as less than about 150 microns, such as less than about 125 microns. The average particle size can be greater than about 20 microns, such as greater than about 30 microns, such as greater than about 40 microns, such as greater than about 50 microns.

In another aspect, the wicking enhancing agent can comprise an olefinic copolymer. In one aspect, the olefinic copolymer can be an ethylene vinyl acetate copolymer which is generally derived from at least one ethylene monomer and at least one vinyl acetate monomer. Certain aspects of the copolymer can be selectively controlled to help achieve the desired properties. For instance, the vinyl acetate content of the copolymer may be selectively controlled to be relatively low. For example, commercially available ethylene vinyl acetate copolymers can contain vinyl acetate in an amount up to about 60% by weight. It was discovered, however, that ethylene vinyl acetate copolymers having a relatively low vinyl acetate monomer content have better compatibility with one or more high density polyethylene polymers when extruded together. Lower amounts of vinyl acetate monomer, for instance, lead to the production of polymer articles having better mechanical properties with less phase separation.

In one aspect, for instance, the ethylene vinyl acetate copolymer can have a vinyl acetate monomer content of less than about 30% by weight, such as less than about 29% by weight, such as less than about 25% by weight, such as less than about 20% by weight, such as less than about 15% by weight, such as less than about 14% by weight, such as less than about 13% by weight, and generally greater than about 3% by weight, such as greater than about 5% by weight, such as greater than about 6% by weight, such as greater than about 7% by weight such as greater than about 8% by weight, such as greater than about 9% by weight, such as greater than about 10% by weight, such as greater than about 11% by weight.

The melt flow rate or melt flow index of the ethylene vinyl acetate copolymer is also relatively low. For instance, the melt flow index of the ethylene vinyl acetate copolymer can be less than about 20 g/10 min, such as less than about 10 g/10 min, such as less than about 8 g/10 min, such as less than about 5 g/10 min, such as less than about 4 g/10 min, such as less than about 3 g/10 min, and generally greater than about 0.1 g/10 min, such as greater than about 0.8 g/10 min, such as greater than about 1.2 g/10 min. Melt flow index can be measured according to ASTM Test D1238-20 at a temperature of 190° C. and at a load of 2.16 kilograms for the ethylene vinyl acetate copolymer component.

The density of the ethylene vinyl acetate copolymer(s) may range from about 0.900 to about 1.00 gram per cubic centimeter (g/cm³), in some embodiments from about 0.910 to about 0.980 g/cm³, and in some embodiments, from about 0.920 to about 0.975 g/cm³, as determined in accordance with ASTM D1505-18. The melting temperature of the ethylene vinyl acetate copolymer may be from about 70° C. to about 115° C., in some embodiments from about 80° C. to about 110° C., and in some embodiments, from about 95° C. to about 105° C., such as determined in accordance with ASTM D3418-15.

Any of a variety of techniques may generally be used to form the ethylene vinyl acetate copolymer(s) with the desired properties. In one embodiment, the polymer is produced by copolymerizing an ethylene monomer and a vinyl acetate monomer in a high pressure reaction. Vinyl acetate may be produced from the oxidation of butane to yield acetic anhydride and acetaldehyde, which can react together to form ethylidene diacetate. Ethylidene diacetate can then be thermally decomposed in the presence of an acid catalyst to form the vinyl acetate monomer. Examples of suitable acid catalysts include aromatic sulfonic acids (e.g., benzene sulfonic acid, toluene sulfonic acid, ethylbenzene sulfonic acid, xylene sulfonic acid, and naphthalene sulfonic acid), sulfuric acid, and alkanesulfonic acids, such as described in U.S. Pat. No. 2,425,389 to Oxley et al.; U.S. Pat. No. 2,859,241 to Schnizer; and U.S. Pat. No. 4,843,170 to Isshiki et al. The vinyl acetate monomer can also be produced by reacting acetic anhydride with hydrogen in the presence of a catalyst instead of acetaldehyde. This process converts vinyl acetate directly from acetic anhydride and hydrogen without the need to produce ethylidene diacetate. In yet another embodiment, the vinyl acetate monomer can be produced from the reaction of acetaldehyde and a ketene in the presence of a suitable solid catalyst, such as a perfluorosulfonic acid resin or zeolite.

In addition to controlling monomer content, in one aspect, the particle size of the olefinic copolymer, such as the particle size of the ethylene vinyl acetate copolymer, can be controlled when blended with one or more high density polyethylene polymers. For instance, the median particle size of the ethylene vinyl acetate copolymer can be within about 60%, such as within about 50%, such as within about 40%, such as within about 30%, such as within about 20%, such as within about 10% of the median particle size of the high density polyethylene polymer particles.

In another aspect, the particle size of the olefinic copolymer, such as the particle size of the ethylene vinyl acetate copolymer, can be much larger than the particle size of the one or more high density polyethylene polymers. For instance, in one aspect, the high density polyethylene particles can be combined with an ethylene vinyl acetate copolymer in the form of pellets.

In one aspect, the ethylene vinyl acetate copolymer particles can have a median particle size of greater than about 0.5 mm, such as greater than about 1 mm, such as greater than about 2 mm, and less than about 5 mm, such as less than about 4.5 mm. In another aspect, the ethylene vinyl acetate copolymer particles can be produced and/or ground so as to have a median particle size of less than about 1000 microns, such as less than about 700 microns, such as less than about 500 microns, such as less than about 300 microns, such as less than about 200 microns, such as less than about 150 microns. The median particle size of the ethylene vinyl acetate copolymer particles can be greater than about 50 microns, such as greater than about 75 microns, such as greater than about 100 microns, such as greater than about 200 microns, such as greater than about 300 microns, such as greater than about 400 microns, such as greater than about 500 microns, such as greater than about 600 microns.

The amount of olefinic copolymer or ethylene vinyl acetate copolymer incorporated into the polymer articles made according to the present disclosure can vary depending upon the particular application and the desired result. In general, polymer articles made according to the present disclosure can contain one or more ethylene vinyl acetate copolymers in an amount of from about 0.1% by weight to about 30% by weight, including all increments of 0.1% by weight therebetween. For example, the polymer articles can contain one or more ethylene vinyl acetate copolymers in an amount greater than about 0.3% by weight, such as in an amount greater than about 0.8% by weight, such as in an amount greater than about 1% by weight, such as in an amount greater than about 1.5% by weight, such as in an amount greater than about 2% by weight, such as in an amount greater than about 2.5% by weight, such as in an amount greater than about 3% by weight, such as in an amount greater than about 3.5% by weight, such as in an amount greater than about 4% by weight, such as in an amount greater than about 4.5% by weight, such as in an amount greater than about 5% by weight. One or more ethylene vinyl acetate copolymers can be present in the polymer articles in an amount less than about 25% by weight, such as in an amount less than about 20% by weight, such as in an amount less than about 18% by weight, such as in an amount less than about 15% by weight, such as in an amount less than about 12% by weight, such as in an amount less than about 10% by weight, such as in an amount less than about 8% by weight, such as in an amount less than about 6% by weight. In various embodiments, one or more vinyl acetate copolymers can be present in the polymer articles in an amount from about 1% by weight to about 12% by weight, such as in an amount from about 1.5% by weight to about 4.5% by weight.

In one aspect, in addition to incorporating one or more wicking enhancing agents into the polymer membrane or instead of incorporating one or more wicking enhancing agents into the membrane, the membrane is subjected to a surface treatment that improves the compatibility between the membrane and the electrolyte. The surface treatment can be applied to one surface or to opposite surfaces of the membrane or film. In one embodiment, for instance, the porous membrane can be subjected to a plasma treatment. The plasma treatment, for instance, can oxidize the polyethylene polymer to form polar groups that increase the polarity of the surface of the porous polymer membrane. In one aspect, for instance, the surface treatment can be directed to an oxygen plasma treatment that not only greatly improves the compatibility of the porous membrane with an electrolyte but does so without adversely impacting the mechanical properties of the film.

For example, in one aspect, the plasma process of the present disclosure is conducted using microwave discharge. In addition, the process can be carried out at very low pressures and at extremely short contact times so as to preserve the physical properties of the porous polymer film.

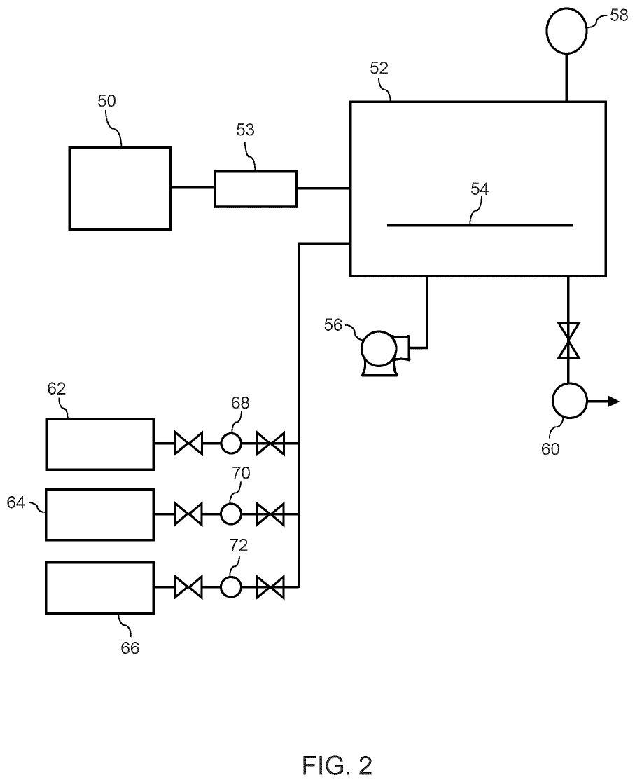

One embodiment of a plasma process that may be used in accordance with the present disclosure is shown in FIG. 2. Referring to FIG. 2, the plasma process includes a microwave supply 50 that is in communication with a vacuum chamber 52 via a resonant cavity 53. The resonant cavity 53 can include or be associated with an impedance matching system. A substrate holder 54 is contained within the vacuum chamber 52. The vacuum chamber 52 is also associated with a pressure monitoring device 58.

In order to evacuate the chamber 52, the chamber 52 can be placed in communication with a pump 56. The vacuum chamber 52 is also in communication with an exhaust 60.

As shown in FIG. 2, the vacuum chamber 52 can also be placed in fluid communication with one or more gas supplies. In the embodiment illustrated in FIG. 2, three different gas supplies are shown 62, 64, and 66. Each gas supply 62, 64, and 66 is placed in association with a corresponding mass flow rate controller 68, 70, and 72. The gas supplies 62, 64, and 66 are for feeding oxygen alone or in combination with other gases to the vacuum chamber 52.

As described above, in one embodiment, a microwave plasma reactor is used to deliver an oxygen plasma to the porous polymer films. Although other plasma reactors may be used in accordance with the present disclosure, in one embodiment, a low pressure plasma system with microwave discharge is preferred. Alternatively, inductively coupled plasma systems that contain an RF generator can be used.

During oxygen plasma treatment, a porous polymer film sample is placed into the vacuum chamber 52 and the chamber is evacuated using the pump 56. A plasma is then fed to the vacuum chamber 52 produced by the microwave supply 50 in conjunction with one or more gases that contain oxygen. Sources of oxygen can vary depending upon the particular application. In one embodiment, pure oxygen gas is fed to the vacuum chamber 52. In alternative embodiments, however, oxygen can be combined with other gases, such as inert gases. For instance, oxygen can be combined with nitrogen. In one embodiment, air is fed to the plasma chamber 52. Other sources of oxygen include hydrogen peroxide, water (steam), nitrous oxide, ozone, and the like. In one embodiment, the gas that is fed to the plasma chamber 52 contains greater than about 20% oxygen, such as greater than about 30% oxygen, such as greater than about 50% oxygen by volume.

During oxygen plasma treatment, an ionized gas is formed that contains various different positive and negative ions and optionally free radicals, photons, and neutral species. The ionized gas initiates reactions on the surface of the porous polymer film that ultimately modify the chemical properties of the surface. For instance, the polyethylene polymer can be oxidized in the presence of oxygen. The plasma oxidized surface, for instance, can contain various different polar groups that increase the polarity of the surface of the porous polymer film.

The conditions within the plasma chamber 52 during the plasma process can vary. In one embodiment, the oxygen plasma process is carried out at low pressures. For instance, the pressure within the chamber can be maintained below one atmosphere. For instance, the pressure within the chamber can be below about 10,000 pa, such as less than about 5,000 pa, such as less than about 1,000 pa, such as less than about 500 pa, such as less than about 300 pa, such as less than about 200 pa. In one embodiment, the process is carried out at very low pressures such as less than about 150 pa, such as less than about 130 pa, such as less than about 100 pa, such as less than about 80 pa, such as less than about 50 pa, such as less than about 30 pa. The temperature during the process can generally be less than about 60° C., such as less than about 50° C., such as less than about 40° C., such as less than about 30° C., such as less than about 28° C., such as less than about 25° C., and generally greater than about 15° C., such as greater than about 20° C.

In accordance with the present disclosure, the contact time between the porous polymer film and the oxygen plasma, in one embodiment, can be relatively short. For example, in one embodiment, each side of the porous polymer film can be exposed to the plasma for times of less than about 30 seconds, such as less than about 25 seconds, such as less than about 20 seconds, such as less than about 15 seconds, such as less than about 12 seconds, such as less than about 10 seconds, such as less than about 8 seconds, such as less than about 6 seconds. Contact times are generally greater than about 1 second, such as greater than about 2 seconds, such as greater than about 3 seconds. It was discovered that very short contact times provide the necessary ion conductivity without adversely impacting the physical properties of the film, especially when using microwave generated plasma at low pressures.

As described above, porous polymer films made according to the present disclosure are formed from one or more high density polyethylene polymers. The high density polyethylene has a density of about 0.93 g/cm³ or greater, such as about 0.94 g/cm³ or greater, such as about 0.95 g/cm³ or greater, and generally less than about 1 g/cm³, such as less than about 0.96 g/cm³.

The high density polyethylene polymer can be made from over 90% ethylene derived units, such as greater than 95% ethylene derived units, or from 100% ethylene derived units. The polyethylene can be a homopolymer or a copolymer, including a terpolymer, having other monomeric units.

The high density polyethylene can be a high molecular weight polyethylene, a very high molecular weight polyethylene, and/or an ultrahigh molecular weight polyethylene. “High molecular weight polyethylene” refers to polyethylene compositions with an average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

In one aspect, the high density polyethylene is a homopolymer of ethylene. In another embodiment, the high density polyethylene may be a copolymer. For instance, the high density polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the high density polyethylene may have a monomodal molecular weight distribution. Alternatively, the high density polyethylene may exhibit a bimodal molecular weight distribution. For instance, a bimodal distribution generally refers to a polymer having a distinct higher molecular weight and a distinct lower molecular weight (e.g. two distinct peaks) on a size exclusion chromatography or gel permeation chromatography curve. In another embodiment, the high density polyethylene may exhibit more than two molecular weight distribution peaks such that the polyethylene exhibits a multimodal (e.g., trimodal, tetramodal, etc.) distribution. Alternatively, the high density polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

Any method known in the art can be utilized to synthesize the polyethylene. The polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid fouling and product contamination.

Suitable catalyst systems include but are not limited to Ziegler-Natta type catalysts. Typically, Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system can be obtained by the reaction of a titanium (IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium (IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium (IV) compound with a trialkyl aluminum compound in an inert organic solvent at temperatures in the range of −40° C. to 200° C., preferably −20° C. to 150° C. In the first step the titanium (IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium (IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium, magnesium and zinc stearate.

Optionally, other catalysts such as Phillips catalysts, metallocenes and post metallocenes may be employed. Generally, a cocatalyst such as alumoxane or alkyl aluminum or alkyl magnesium compound is also employed. Other suitable catalyst systems include Group 4 metal complexes of phenolate ether ligands.

Polyethylene polymers particularly well suited for use in the present disclosure have a full width at half maximum of a melting endothermic peak when measured with a differential scanning calorimeter of greater than about 6 degrees C., such as greater than about 6.2 degrees C., such as greater than about 6.4 degrees C., such as greater than about 6.5 degrees C., such as greater than about 6.8 degrees C., and generally less than about 9 degrees C. The polyethylene polymer can also have a half-crystallization time period during an isothermal crystallization at 123° C. of greater than about 2 minutes, such as greater than about 2.5 minutes, such as greater than about 3.0 minutes, such as greater than about 3.5 minutes, such as greater than about 4.0 minutes, such as greater than about 4.5 minutes, and generally less than about 12 minutes.

In one embodiment, the polyethylene particles are optionally made from a polyethylene polymer having a relatively low bulk density as measured according to DIN53466. For instance, in one embodiment, the bulk density is generally less than about 0.4 g/cm³, such as less than about 0.35 g/cm³, such as less than about 0.33 g/cm³, such as less than about 0.3 g/cm³, such as less than about 0.28 g/cm³, such as less than about 0.26 g/cm³. The bulk density is generally greater than about 0.1 g/cm³, such as greater than about 0.15 g/cm³. In one embodiment, the polymer has a bulk density of from about 0.2 g/cm³ to about 0.27 g/cm³.

In one embodiment, the polyethylene particles can be a free-flowing powder. The particles can have a median particle size (d50) by volume of less than 200 microns. For example, the median particle size (d50) of the polyethylene particles can be less than about 150 microns, such as less than about 125 microns. The median particle size (d50) is generally greater than about 20 microns. The powder particle size can be measured utilizing a laser diffraction method according to ISO 13320.

In one embodiment, 90% of the polyethylene particles can have a particle size of less than about 250 microns. In other embodiments, 90% of the polyethylene particles can have a particle size of less than about 200 microns, such as less than about 170 microns.

The molecular weight of the polyethylene polymer can vary depending upon the particular application. The polyethylene polymer, for instance, may have an average molecular weight, as determined according to the Margolies equation. The molecular weight can be determined by first measuring the viscosity number according to DIN EN ISO Test 1628. Dry powder flow is measured using a 25 mm nozzle. The molecular weight is then calculated using the Margolies equation from the viscosity numbers. The average molecular weight is generally greater than about 300,000 g/mol, such as greater than about 500,000 g/mol, such as greater than about 650,000 g/mol, such as greater than about 1,000,000 g/mol, such as greater than about 2,000,000 g/mol, such as greater than about 2,500,000 g/mol, such as greater than about 3,000,000 g/mol, such as greater than about 4,000,000 g/mol. The average molecular weight is generally less than about 13,000,000 g/mol.

In one aspect, the composition or membrane can include only a single polyethylene polymer. The single polyethylene polymer can have an average molecular weight of 500,000 g/mol or greater, such as greater than about 600,000 g/mol and generally less than about 12,500,000 g/mol, such as less than about 10,000,000 g/mol, such as less than about 6,000,000 g/mol, such as less than about 5,000,000 g/mol.

The polyethylene may have a viscosity number of from at least 100 mL/g, such as at least 500 mL/g, such as at least 550 mL/g, to less than about 6,000 mL/g, such as less than about 5,000 mL/g, such as less than about 4000 mL/g, such as less than about 3,000 mL/g, such as less than about 1,000 mL/g, as determined according to ISO 1628 part 3 utilizing a concentration in decahydronapthalene of 0.0002 g/mL.

The high density polyethylene may have a crystallinity of from at least about 40% to 85%, such as from 45% to 80%. In one aspect, the crystallinity can be greater than about 50%, such as greater than about 55%, such as greater than about 60%, such as greater than about 65%, such as greater than about 70%, and generally less than about 80%.

In one aspect, the polymer composition can contain a blend of high density polyethylene polymers. Each of the polyethylene polymers contained in the composition of the present disclosure have a different molecular weight, particularly a different average molecular weight. In one aspect, gel extruded articles can be made according to the present disclosure that can contain at least two different types of polyethylene polymers, such as at least three different types of polyethylene polymers. The polymer composition used to produce the gel extruded articles, for instance, can include a first polyethylene polymer having a relatively low molecular weight, a second polyethylene polymer having a mid-range molecular weight and a third polyethylene polymer having a relatively high molecular weight.

The first polyethylene polymer contained in the polymer composition of the present disclosure, for instance, can have a lower molecular weight than the second polyethylene polymer and the third polyethylene polymer. The first polyethylene polymer, for instance, can have a molecular weight of generally from about 200,000 g/mol to about 1.1 million g/mol, such as from about 300,000 g/mol to about 1 million g/mol, including all increments of 50 g/mol therebetween. For instance, the molecular weight can be greater than about 400,000 g/mol, such as greater than about 500,000 g/mol, such as greater than about 550,000 g/mol, such as greater than about 580,000 g/mol. The molecular weight can be less than about 900,000 g/mol, such as less than about 800,000 g/mol, such as less than about 700,000 g/mol, such as less than about 650,000 g/mol.

The amount that the first polyethylene polymer is present in the polymer composition can vary depending upon various factors including the desired result. In one aspect, the first polyethylene polymer can be added to the polymer composition in an amount sufficient to improve processing of the composition, especially during gel extrusion processes. In one embodiment, the first polyethylene polymer is present in the polymer composition (based on the total amount of polymers present) or in any article formed from the polymer composition in an amount greater than about 3% by weight, such as in an amount greater than about 5% by weight, such as in an amount greater than about 8% by weight, such as in an amount greater than about 9% by weight, and generally in an amount less than about 75%, such as in an amount less than about 25% by weight, such as in an amount less than about 18% by weight, such as in an amount less than about 15% by weight, such as in an amount less than about 12% by weight based upon the total amount of polyethylene polymer present in the polymer composition or article made from the composition. For instance, the above weight percentages are based upon the total amount of the first polyethylene polymer present, the second polyethylene polymer present, and the third polyethylene polymer present.

The second polyethylene polymer present in the polymer composition generally can have a molecular weight of from about 1,100,000 g/mol to about 3,100,000 g/mol, such as from about 1,200,000 g/mol to about 2,900,000 g/mol, including all increments of 50,000 g/mol therebetween. For instance, the second polyethylene polymer can have a molecular weight of greater than about 1,300,000 g/mol, such as greater than about 1,400,000 g/mol, such as greater than about 1,500,000 g/mol, such as greater than about 1,700,000 g/mol, such as greater than about 1,800,000 g/mol, such as greater than about 1,900,000 g/mol, and generally less than about 2,900,000 g/mol, such as less than about 2,500,000 g/mol, such as less than about 2,200,000 g/mol, such as less than about 2,100,000 g/mol, such as less than about 2,050,000 g/mol.

The second polyethylene polymer can be present in the polymer composition or in articles made from the composition in an amount greater than the first polyethylene polymer and the third polyethylene polymer or can be present in amounts less than the other polyethylene polymers. In one aspect, the second polyethylene polymer can be the primary polymer contained in the polymer composition. In other embodiments, however, the first or the third polyethylene polymer may be present in an amount greater than the second polyethylene polymer. The second polyethylene polymer can be present in the polymer composition, based on the total amount of polyethylene polymer present, in an amount greater than about 5% by weight, such as in an amount greater than about 30% by weight, such as in an amount greater than about 34% by weight, such as in an amount greater than about 38% by weight, such as in an amount greater than about 42% by weight, such as in an amount greater than about 50% by weight, such as in an amount greater than about 53% by weight, such as in an amount greater than about 58% by weight, such as in an amount greater than about 62% by weight, such as in an amount greater than about 65% by weight, such as in an amount greater than about 73% by weight. The second polyethylene polymer is generally present in the polymer composition or in articles made from the composition in an amount less than about 85% by weight, such as in an amount less than about 80% by weight, such as in an amount less than about 78% by weight, such as in an amount less than about 60% by weight, such as in an amount less about 35% by weight, such as in an amount less than about 20% by weight, based upon the total amount of polyethylene polymer present in the composition.

The third polyethylene polymer having the highest molecular weight can generally have a molecular weight of from about 3.1 million g/mol to about 5.2 million g/mol, such as from about 3.2 million g/mol to about 4.6 million g/mol, including all increments of 50,000 g/mol therebetween. For instance, the third polyethylene polymer can have a molecular weight of greater than about 3,300,000 g/mol, such as greater than about 3,350,000 g/mol, such as greater than about 3,400,000 g/mol, such as greater than about 3,450,000 g/mol. The molecular weight of the third polyethylene polymer is generally less than about 4,400,000 g/mol, such as less than about 3,900,000 g/mol, such as less than about 3,800,000 g/mol, such as less than about 3,750,000 g/mol, such as less than about 3,700,000 g/mol.

The third polyethylene polymer can be present in the polymer composition generally in an amount from about 5% by weight to about 45% by weight, based upon the total weight of polyethylene polymer present in the composition. For example, the third polyethylene polymer can be present in the polymer composition in an amount greater than about 10% by weight, such as in an amount greater than about 12% by weight, such as in an amount greater than about 14% by weight, such as in an amount greater than about 18% by weight, such as in an amount greater than about 22% by weight, such as in an amount greater than about 25% by weight, such as in an amount greater than about 28% by weight, such as in an amount greater than about 30% by weight, such as in an amount greater than about 35% by weight. The third polyethylene polymer is generally present in an amount less than about 40% by weight, such as in an amount less than about 35% by weight, such as in an amount less than about 30% by weight, such as in an amount less than about 28% by weight, such as in an amount less than about 24% by weight, such as in an amount less than about 20% by weight, such as in an amount less than about 18% by weight, such as in an amount less than about 15% by weight, based upon the total weight of polyethylene polymer present in the composition.

Prior to forming articles from the polymer composition of the present disclosure, each of the polyethylene polymers can be present in the form of particles. For example, in one embodiment, the polymer composition contains particles only formed from the first polyethylene polymer, particles only formed from the second polyethylene polymer, and particles only formed from the third polyethylene polymer that have been blended together. Alternatively, two or more of the polyethylene polymers can be preblended or compounded together. For instance, the polymer particles can contain at least two of the polyethylene polymers. Each particle, for instance, can contain a combination of the second polyethylene polymer and the third polyethylene polymer, a combination of the first polyethylene polymer and the second polyethylene polymer, a combination of the first polyethylene polymer and the third polyethylene polymer, or can contain a combination of the first polyethylene polymer, the second polyethylene polymer, and the third polyethylene polymer.

In forming porous polymer films in accordance with the present disclosure, the high density polyethylene particles are combined with a plasticizer and then gel extruded.

When combined with a plasticizer in forming porous films or membranes, the high density polyethylene particles are present in the polymer composition in an amount up to about 50% by weight. For instance, the high density polyethylene particles can be present in the polymer composition in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 15% by weight. The polyethylene particles can be present in the composition in an amount greater than about 5% by weight, such as in an amount greater than about 10% by weight, such as in an amount greater than about 15% by weight, such as in an amount greater than about 20% by weight, such as in an amount greater than about 25% by weight.

During gel processing, a plasticizer is combined with the high density polyethylene particles which can be substantially or completely removed in forming polymer articles. For example, in one embodiment, the resulting polymer article can contain the high density polyethylene polymer in an amount greater than about 50% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight, such as in an amount greater than about 99% by weight, such as in an amount greater than about 99.5% by weight.

The plasticizer, for instance, may comprise a hydrocarbon oil, an alcohol, an ether, an ester such as a diester, or mixtures thereof. For instance, suitable plasticizers include mineral oil, a paraffinic oil, decaline, and the like. Other plasticizers include xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, and the like. In one embodiment, the plasticizer may comprise a halogenated hydrocarbon, such as monochlorobenzene. Cycloalkanes and cycloalkenes may also be used, such as camphene, methane, dipentene, methylcyclopentandiene, tricyclodecane, 1,2,4,5-tetramethyl-1,4-cyclohexadiene, and the like. The plasticizer may comprise mixtures and combinations of any of the above as well.

The plasticizer is generally present in the composition used to form the polymer articles in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight. In fact, the plasticizer can be present in an amount up to about 99.5% by weight.

The high density polyethylene particles blend with the plasticizer to form a homogeneous gel-like material.

In order to form polymer articles in accordance with the present disclosure, the high density polyethylene particles are combined with the plasticizer and extruded through a die of a desired shape. In one embodiment, the composition can be heated within the extruder. For example, the plasticizer can be combined with the particle mixture and fed into an extruder. In accordance with the present disclosure, the plasticizer and particle mixture form a homogeneous gel-like material prior to leaving the extruder for forming polymer articles with little to no impurities.

In one embodiment, elongated articles, such as films, are formed during the gel spinning or extruding process.

During the process, at least a portion of the plasticizer is removed from the final product. The plasticizer removal process may occur due to evaporation when a relatively volatile plasticizer is used. Otherwise, an extraction liquid can be used to remove the plasticizer. The extraction liquid may comprise, for instance, a hydrocarbon solvent. One example of the extraction liquid, for instance, is dichloromethane. Other extraction liquids include acetone, chloroform, an alkane, hexene, heptene, an alcohol, or mixtures thereof.

If desired, the resulting polymer article can be stretched at an elevated temperature below the melting point of the polyethylene polymer to increase strength and modulus. Suitable temperatures for stretching are in the range of from about ambient temperature to about 155° C. The draw ratios can generally be greater than about 4, such as greater than about 6, such as greater than about 8, such as greater than about 10, such as greater than about 15, such as greater than about 20, such as greater than about 25, such as greater than about 30. In certain embodiments, the draw ratio can be greater than about 50, such as greater than about 100, such as greater than about 110, such as greater than about 120, such as greater than about 130, such as greater than about 140, such as greater than about 150. Draw ratios are generally less than about 1,000, such as less than about 800, such as less than about 600, such as less than about 400. In one embodiment, lower draw ratios are used such as from about 4 to about 10. The polymer article can be uniaxially stretched or biaxially stretched.

In one embodiment, the process is used to produce a membrane. The membrane or film can be used, for instance, as a battery separator. Alternatively, the membrane can be used as a microfilter.

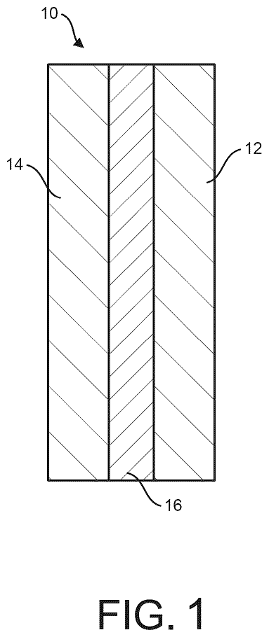

Referring to FIG. 1, one embodiment of an ion battery 10 made in accordance with the present disclosure is shown. The battery 10 includes an anode 12 and a cathode 14. The anode 12, for instance, can be made from a carbon source, such as graphite. The cathode 14, on the other hand, can be made from sulfur, a sodium salt, or from an intercalated lithium metal oxide. In accordance with the present disclosure, the battery 10 further includes a porous membrane 16 or separator that is positioned between the anode 12 and the cathode 14. The porous membrane 16 minimizes electrical shorts between the two electrodes while allowing the passage of ions, such as lithium ions. As shown in FIG. 1, in one embodiment, the porous membrane 16 is a single layer polymer membrane and does not include a multilayer structure. In one aspect, the single layer polymer membrane may also include a coating. The coating can be an inorganic coating made from, for instance, aluminum oxide or a titanium oxide. Alternatively, the single layer polymer membrane may also include a polymeric coating. The coating can provide increased thermal resistance.

In one embodiment, the cathode can contain NCM, NCA, NCMA, and/or LFP in combination with a PVDF binder and is made in a wet process with NMP as solvent. The cathode can be in contact with an aluminum layer. The anode can contain graphite in combination with an SBR or CMC binder and is made in a wet process with water as solvent. The anode can be in contact with a copper layer.

As described above, porous membranes made according to the present disclosure not only have excellent strength properties but also have excellent wicking properties. The enhanced wicking properties against electrolytes can significantly decrease the time needed to produce a battery from the membrane.

Batteries made according to the present disclosure include pouch cells, prismatic cells, cylindrical cells, and coin cells. Various tests can be conducted on the battery to test for aging, resistance/impedance, and capacity. For example, a battery cycle aging test can be conducted at a C-rate of 0.1-5C, at a temperature of from Room temperature-100° C., while charging/discharging up to 10,000 cycles, while measuring the amount of cycles that it takes to reach 80% of battery capacity. Batteries made according to the present disclosure can display over 3% more cycles until 80% battery capacity is reached in comparison to a battery made from an identical membrane not subjected at least one wicking enhancing treatment and/or containing at least one wicking enhancing agent.

Another battery test includes analysing homogeneity/drying of separator in post-mortem analysis after specific amount of cycles (e.g. 300). The hydrophilic membranes will contain a higher amount of solvent in comparison to reference samples and thus show less defect areas.

Another battery test is the EIS test (AC) or impedance testing. The conditions for this test include state of charge (SOC) to be from 0-100%, at a temperature of from room temperature to 100° C. Batteries made according to the present disclosure can display over 5% lower resistance in comparison to a battery made from an identical membrane not subjected at least one wicking enhancing treatment and/or containing at least one wicking enhancing agent.

Still another battery test is the capacity test. The capacity test occurs during charging-discharging (formation)/aging. The temperature range is from room temperature to 100° C. After battery aging, final capacity is measured. Batteries made according to the present disclosure can reach final capacity at least 10% earlier in comparison to a battery made from an identical membrane not subjected at least one wicking enhancing treatment and/or containing at least one wicking enhancing agent.

Another battery test is the electrolyte filling test. As described above, membranes made according to the present disclosure can have greater soaking speeds and can display a greater soaking distance, which translate into a faster filling of electrolyte in the cell.

The membrane with enhanced electrolyte compatibility, for instance, can significantly decrease the electrolyte filling step, the charging and discharging step (formation), and the aging step in producing batteries. For instance, it is believed that membranes made according to the present disclosure can decrease the battery manufacturing time by greater than 5%, such as by greater than 10%. In addition to reducing the time to make the batteries, the resulting batteries also have better properties including a greater life span.

The polymer composition and polymer articles made in accordance with the present disclosure may contain various other additives, such as heat stabilizers, light stabilizers, UV absorbers, acid scavengers, flame retardants, lubricants, colorants, and the like.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxbenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, triaryl phosphates, trichloropropylphosphate (TCPP), magnesium hydroxide, aluminum trihydroxide, antimony trioxide.

In one embodiment, a lubricant may be present in the composition. The lubricant may include, but is not limited to, silicone oil, waxes, molybdenum disulfide, or any combination thereof.

In one embodiment, a colorant may be present in the composition. The colorant may include, but is not limited to, inorganic and organic based color pigments.

In one aspect, an acid scavenger may be present in the polymer composition. The acid scavenger, for instance, may comprise an alkali metal salt or an alkaline earth metal salt. The salt can comprise a salt of a fatty acid, such as a stearate. Other acid scavengers include carbonates, oxides, or hydroxides. Particular acid scavengers that may be incorporated into the polymer composition include a metal stearate, such as calcium stearate. Still other acid scavengers include zinc oxide, calcium carbonate, magnesium oxide, and mixtures thereof.

These additives may be used singly or in any combination thereof. In general, each additive may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %. The sum of the wt. % of all of the components, including any additives if present, utilized in the polymer composition will be 100 wt. %.

The present disclosure may be better understood with reference to the following example. The following example is given below by way of illustration and not by way of limitation. The following experiments were conducted in order to show some of the benefits and advantages of the present invention.

### Example No. 1

Various resin compositions were formulated containing a base resin of high density polyethylene. The high density polyethylene polymer was combined with wicking enhancing agents in accordance with the present disclosure and formed into porous membranes. The porous membranes were subjected to the soaking test in propylene carbonate and tested for their wicking properties and compared to membranes made from the same high density polyethylene polymer but containing no wicking enhancement agents.

Specifically, the membranes made according to Sample No. 1 contained 50% by weight of the high density polyethylene polymer combined with 50% by weight of a high density polyethylene polymer grafted to acrylic acid groups in an amount of 4.6% by weight. The membranes made according to Sample No. 2 contained the high density polyethylene polymer combined with 3.5% by weight of an ethylene vinyl acetate copolymer containing 12% by weight vinyl acetate. The high density polyethylene polymer had a molecular weight of 700,000 g/mol and an average particle size (d50) of about 115 microns. The polyethylene polymer had a melt flow rate of 0.5 g/10 min. Sample No. 3 was made solely from the high density polyethylene polymer.

The resin compositions were prepared into membranes via gel extrusion, biaxial stretching, and solvent extraction as are conventional.

The blends were gel extruded using a solid content of 30 wt. % resin and paraffin oil at a temperature of from about 190° C. to about 240° C. and a screw speed of 200 rpm. After extrusion, the resulting membrane was solidified on a chill roller set to 40° C. Stretching was performed at an approximate ratio of 7×7 (MD/TD) at a temperature of 120° C. Extraction of the stretched membranes was performed in acetone. The membranes were annealed at 120° C. for 10 minutes.

The membranes were then tested according to the soaking test with propylene carbonate. As described above, it was discovered that the soaking distance is dependent upon the Gurley permeability of the porous membrane and the thickness of the membrane. For the membranes produced, the soaking distance was measured in relation to the Gurley permeability in sec/100 mL divided by the thickness of the membrane in microns. The following results were obtained:

| | |
|---|---|
| Gurley (sec/100 mL)/ | |
| thickness (microns) | Soaking distance (mm) |

Sample No. 1

| | |
|---|---|
| 20.48 | 13.33 |
| 23.24 | 11.90 |
| 28.14 | 10.95 |
| 20.90 | 12.62 |
| 26.70 | 10.95 |
| 35.89 | 9.52 |
| 38.95 | 9.29 |
| 32.54 | 9.29 |
| 35.85 | 9.52 |
| 31.39 | 9.52 |
| 31.74 | 10.48 |
| 40.63 | 9.05 |
| 33.88 | 9.52 |
| 56.87 | 8.10 |

Sample No. 2

| | |
|---|---|
| 31.75 | 11.67 |
| 26.95 | 12.14 |
| 24.92 | 12.38 |
| 35.53 | 9.76 |
| 25.31 | 11.67 |
| 33.49 | 10.48 |
| 26.12 | 12.62 |
| 23.48 | 13.81 |
| 52.05 | 8.57 |
| 55.91 | 7.86 |
| 56.50 | 6.67 |
| 65.20 | 6.67 |
| 54.01 | 9.29 |
| 59.36 | 7.38 |
| 70.09 | 7.62 |

Sample No. 3

| | |
|---|---|
| 23.59 | 10.00 |
| 35.31 | 7.38 |
| 40.41 | 4.52 |
| 26.89 | 8.10 |
| 49.02 | 3.57 |
| 27.97 | 8.33 |
| 35.67 | 6.19 |
| 56.24 | 3.57 |
| 63.58 | 3.10 |
| 35.99 | 7.86 |
| 82.37 | 0.95 |
| 72.09 | 3.10 |
| 63.93 | 1.19 |
| 25.42 | 9.05 |
| 22.07 | 8.57 |
| 23.32 | 9.29 |
| 22.96 | 8.81 |

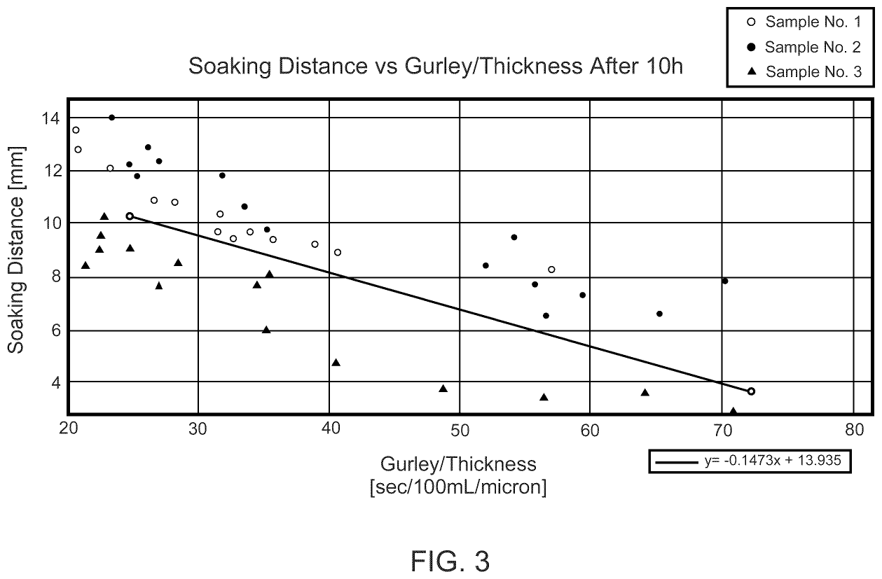

The results above are graphically illustrated in FIG. 3. As shown, porous membranes made according to the present disclosure displayed a dramatically improved soaking distance in relation to the reference samples. As shown, all of the samples made in accordance with the present disclosure had a soaking distance in millimeters that was greater than the following relationship:

$$Soaking distance ( mm ) \geq - 0.1473 ( x ) + 13.935$$

where x is the Gurley permeability (sec/100 mL)/thickness (microns).

The membranes were also tested for soaking speed in mm distance per hour after 20 hours. Sample No. 3 made from the reference data exhibited a soaking speed of 0.5 mm/hr. The Sample No. 1 membranes made according to the present disclosure displayed a soaking speed of 0.7 mm/hr. The Sample No. 2 membranes made according to the present disclosure, however, displayed a soaking speed of 0.8 mm/hr. Consequently, not only do membranes made according to the present disclosure display a much greater soaking distance but also do so at a rapid rate.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A separator for separating an anode from a cathode in an energy storage device, the separator comprising:
a porous membrane comprising at least one high density polyethylene polymer, the at least one high density polyethylene polymer having an average molecular weight of from about 400,000 g/mol to about 12,000,000 mol, the at least one high density polyethylene polymer being present in the porous membrane in an amount of at least about 30% by weight, the porous membrane having a thickness of from about 3 microns to about 25 microns, the porous membrane having a Gurley permeability of from about 50 sec/100 mL to about 1,000 sec/100 mL, the porous membrane having a porosity of from about 20% to about 60%, and wherein the porous membrane displays electrolyte wetting properties such that the porous membrane displays a soaking speed in propylene carbonate after 20 hours of greater than about 0.52 mm/hr.

2. A separator as defined in claim 1, wherein the porous membrane displays a soaking speed after 20 hours in propylene carbonate of greater than about 0.55 mm/hr for membranes having a Gurley permeability/thickness value of from about 10 s/100 cc/μm to about 40 s/100 cc/μm.

3. A separator as defined in claim 1, wherein the porous membrane displays a soaking distance in propylene carbonate according to the following relationship:
$$soaking distance ( mm ) \geq - 0.1473 x + 13.935$$
wherein x is Gurley permeability (sec/100 mL) per thickness of the porous membrane (microns).

4. A separator as defined in claim 1, wherein the porous membrane displays a soaking distance in propylene carbonate according to the following relationship:
$$soaking distance ( mm ) \geq - 0.1473 x + 15.5$$
wherein x is Gurley permeability (sec/100 mL) per thickness of the porous membrane (microns).

5. A separator as defined in claim 1, wherein the separator displays a puncture strength of greater than about 500 mN/micron.

6. A separator as defined in claim 1, wherein the porous membrane displays a Gurley permeability of greater than about 120 sec/100 mL to less than about 1,000 sec/100 mL.

7. A separator as defined in claim 1, wherein the porous membrane has a porosity of from about 30% to about 55%.

8. A separator as defined in claim 1, wherein the at least one high density polyethylene polymer has an average molecular weight of from about 600,000 g/mol to about 10,000,000 g/mol.

9. A separator as defined in claim 1, wherein the porous membrane comprises a single layer membrane that is free of polypropylene polymers.

10. A separator as defined in claim 1, wherein the porous membrane contains ethylene vinyl acetate, polyethylene grafted to hydrophilic groups, has a plasma treated surface, or combinations thereof.

11. A separator for separating an anode from a cathode in an energy storage device, the separator comprising:
a porous membrane comprising at least one high density polyethylene polymer, the at least one high density polyethylene polymer having an average molecular weight of from about 400,000 g/mol to about 12,000,000 g/mol, the at least one high density polyethylene polymer being present in the porous membrane in an amount of at least about 30% by weight, the porous membrane having a thickness of from about 3 microns to about 25 microns, the porous membrane having a Gurley permeability of from about 50 sec/100 mL to about 1,000 sec/100 mL, the porous membrane having a porosity of from about 20% to about 60%, and wherein the porous membrane displays electrolyte wetting properties such that the porous membrane displays a soaking distance in propylene carbonate according to the following relationship:
$$soaking distance ( mm ) \geq - 0.1473 x + 13.935$$
wherein x is Gurley permeability (sec/100 mL) per thickness of the porous membrane (microns).

12. A separator as defined in claim 11, wherein the porous membrane displays a soaking distance according to the following relationship:
$$soaking distance ( mm ) \geq - 0.1473 x + 14.5$$
wherein x is Gurley permeability (sec/100 mL) per thickness of the porous membrane (microns).

13. A separator as defined in claim 11, wherein the porous membrane displays a soaking speed after 20 hours in propylene carbonate of greater than about 0.52 mm/hr for membranes having a Gurley permeability/thickness value of from about 10 s/100 cc/μm to about 40 s/100 cc/μm.

14. A separator as defined in claim 11, wherein the separator displays a puncture strength of greater than about 500 mN/micron.

15. A separator as defined in claim 11, wherein the porous membrane displays a Gurley permeability of greater than about 120 sec/100 mL to less than about 1,000 sec/100 mL.

16. A separator as defined in claim 11, wherein the porous membrane has a porosity of from about 30% to about 55%.

17. A separator as defined in any of claims 12 through 18, wherein the at least one high density polyethylene polymer has an average molecular weight of from about 600,000 g/mol to about 10,000,000 g/mol.

18. A separator as defined in claim 11, wherein the porous membrane comprises a single layer membrane that is free of polypropylene polymers.

19. A separator as defined in claim 11, wherein the porous membrane contains ethylene vinyl acetate, polyethylene grafted to hydrophilic groups, has a plasma treated surface, or combinations thereof.

20. A separator for separating an anode from a cathode in an energy storage device, the separator comprising a porous membrane comprising at least one high density polyethylene polymer, the at least one high density polyethylene polymer having an average molecular weight of from about 400,000 g/mol to about 12,000,000 g/mol, the at least one high density polyethylene polymer being present in the porous membrane in an amount of at least about 30% by weight, the porous membrane having a thickness of from about 3 microns to about 25 microns, the porous membrane having a Gurley permeability of from about 50 sec/100 mL to about 1,000 sec/100 mL, the porous membrane having a porosity of from about 20% to about 60%, and wherein the porous membrane contains at least one wicking enhancing treatment and/or at least one wicking enhancing agent that increases the soaking distance (mm) and/or the soaking speed (mm/h) in propylene carbonate by greater than about 5% after 10 hours respectively in comparison to a similar membrane not subjected at least one wicking enhancing treatment and/or containing at least one wicking enhancing agent.
